(19) United States
(12) Patent Application Publication
(10) Pub. No.: US 2019/0327130 A1
(43) Pub. Date: Oct. 24, 2019

(54) METHODS, CONTROL NODE, NETWORK ELEMENT AND SYSTEM FOR HANDLING NETWORK EVENTS IN A TELECOMUNICATIONS NETWORK

(71) Applicant: Telefonaktiebolaget LM Ericsson (publ), Stockholm (SE)

(72) Inventors: Vincent HUANG, Sollentuna (SE); Martha VLACHOU-KONCHYLAKI, Stockholm (SE)

(73) Assignee: Telefonaktiebolaget LM Ericsson (publ), Stockholm (SE)

(21) Appl. No.: 16/475,600

(22) PCT Filed: Jan. 3, 2017
(86) PCT No.: PCT/EP2017/050075

§ 371 Date: Jul. 2, 2019

(51) Int. Cl. H04L 12/24

(52) U.S. Cl. CPC H04L 41/0686; H04L 41/147; H04L 41/069

(57) ABSTRACT

A control node (200), a network element (202) and methods therein, for handling network events occurring in a telecommunications network. During a training phase, network events and/or alarms are collected (2:1) from a first network element (202), such that the control node (200) can define and train (2:2) a prediction model for the first network element (202) based on an event pattern of network events that have occurred prior to detecting a performance related problem. If the same event pattern basically repeats it can be seen as an indication of a forthcoming problem before the problem actually occurs. The control node (200) sends (2:3) the prediction model to the first network element (202), which then can compare the prediction model with further detected network events, and if they match issue a warning (2:6) of a predicted problem.

### TECHNICAL FIELD

The present disclosure relates generally to a control node, a network element and methods therein and a system, for handling network events occurring in a telecommunications network.

### BACKGROUND

In the field of telecommunication, performance and various functions in networks are monitored so that when some problem occurs that affects the performance in some way, an alarm may be issued to notify a network operator about the problem which may need to be resolved or at least addressed by taking some action in the network. For example, various sensors and measuring equipment may be employed to monitor the performance of a node, a communication link or other element in the network. The problem may be caused by a fault in the network equipment or by some changed circumstances such as increased traffic or deteriorated radio conditions in the case of a wireless network.

Typically, when a measured performance related parameter, such as bitrate, throughput, latency, error rate or lost connections, deviates from an expected and desired value or range by exceeding or falling below some predefined threshold, an alarm may be triggered to notify the network operator. Such a change in performance is said to be caused by an “event” in the network which will be generally referred to as a “network event” herein. Further, any part of a telecommunications network that is capable of monitoring performance and of detecting and reporting network events will be referred to as a “network element” in this description. In some non-limiting examples, the network element may be a base station, an access point, a switch, a subscriber database, a gateway, a communication link, a Home Location Register, HLR, and so forth.

In practice, network events are reported and alarms are sent from network elements to a central function that handles and supports operation of the network, commonly referred to as an Operation Support System, OSS, which term will be used herein for short to represent any central function that receives and handles alarms and reported network events. Alternatively, the OSS may also be generally referred to as a “control node”. The OSS can then decide whether an alarm or reported network event motivates some action that is directed to improve or restore the performance, e.g. by reducing the effects of a sudden increase of traffic or radio interference, or by mending a fault that has occurred in the network. For example, the OSS may be configured to initiate an action to address a detected problem in the network when a certain number of alarms and/or network events have been received, e.g. from a certain number of network elements.

However, it is a problem that huge amounts of alarms are commonly triggered in various elements in the network and sent to the OSS since there is usually a great number of network elements such as nodes and links having various detectors, sensors and measuring devices capable of issuing alarms according to predefined rules. FIG. 1 illustrates schematically how an OSS node 100 receives network events and alarms from various network elements, not shown, in a wireless communications network 102, as indicated by an action 1:1. Wireless devices 104 are being served by the network 102 is in this case. Depending on the received network events, the OSS node 100 may issue an alert to notify the operation personnel of the network 102, as shown in an action 1:2, e.g. if the received network events fulfil some predefined trigger condition or the like.

Normally, a substantial part of the issued alarms are not serious enough to require any action, at least not instantly, and the operator may assign a severity level to each alarm to facilitate the decision of whether it must be acted upon or not and/or whether an alert or other action is motivated. The communication and processing of such “insignificant” alarms consume resources in the network and its personnel, often to no avail. In addition, virtually all received alarms need to be checked and cleared manually by a person.

Another problem is that an alarm is triggered after a fault or other problem has already occurred which may already have resulted in reduced performance, and it may take some time for the OSS and its personnel to initiate actions to resolve the problem or mend the fault. Typically, the reduced performance in the network may remain until the problem is resolved.

### SUMMARY

It is an object of embodiments described herein to address at least some of the problems and issues outlined above. It is possible to achieve this object and others by using control node, a network element and methods therein, as defined in the attached independent claims.

According to one aspect, a method is performed by a control node for handling network events occurring in a telecommunications network. In this method the control node collects network events and/or alarms from a first network element in the telecommunications network during a training phase. The control node also detects a performance related problem in the telecommunications network that potentially needs to be addressed, based on the collected network events and/or alarms. Then, the control node identifies an event pattern of network events that have occurred prior to detecting the performance related problem, based on the collected network events and/or alarms. The control node further defines a prediction model for the first network element based on the identified event pattern, and sends the defined prediction model to the first network element. Thereby, the first network element is enabled to use the prediction model for predicting a forthcoming problem and to issue a warning of the predicted problem.

According to another aspect, a control node is arranged to handle network events occurring in a telecommunications network. The control node comprises a memory and a processor, the memory containing instructions executable by the processor such that the control node is operative as follows.

The control node is operative to collect network events and/or alarms from a first network element in the telecommunications network during a training phase, which functionality may be realized by means of a collecting module comprised in the control node. The control node is also operative to detect a performance related problem in the telecommunications network that potentially needs to be addressed, based on the collected network events and/or alarms, which functionality may be realized by means of a detecting module comprised in the control node. The control node is also operative to identify an event pattern of network events that have occurred prior to detecting the performance related problem, based on the collected network events and/or alarms. This functionality may be realized by means of an identifying module comprised in the control node.

The control node is further operative to define a prediction model for the first network element based on the identified event pattern, which functionality may be realized by means of a defining module comprised in the control node. The control node is also operative to send the defined prediction model to the first network element, which functionality may be realized by means of a sending module comprised in the control node. Thereby, the first network element will be enabled to use the prediction model for predicting a forthcoming problem and to issue a warning of the predicted problem.

According to another aspect, a method is performed by a network element for handling network events occurring in a telecommunications network. In this method, the network element receives a prediction model from a control node which prediction model is useful for predicting a forthcoming problem. The network element also detects network events and compares the detected network events and the received prediction model. The network element further issues a warning of a predicted problem when the detected network events match the prediction model in the above comparing operation.

According to another aspect, a network element is arranged to handle network events occurring in a telecommunications network. The network element comprises a memory and a processor, the memory containing instructions executable by the processor such that the network element is operative as follows.

The network element is operative to receive a prediction model from a control node which prediction model is useful for predicting a forthcoming problem, which functionality may be realized by means of a receiving module comprised in the network element. The network element is also operative to detect network events, which functionality may be realized by means of a detecting module comprised in the network element. The network element is then operative to compare the detected network events and the received prediction model, which functionality may be realized by means of a comparing module comprised in the network element.

The network element is further operative to issue a warning of a predicted problem when the detected network events match the prediction model, according to the above comparison, which functionality may be realized by means of a warning module comprised in the network element.

The above methods, control node and network element may be configured and implemented according to different optional embodiments to accomplish further features and benefits, to be described below.

According to another aspect, a system comprising a control node and a network element is also provided, the control node and the network element being operative as described above.

A computer program is also provided comprising instructions which, when executed on at least one processor, cause the at least one processor to carry out either of the methods described above. A carrier is further provided that contains the above computer program, wherein the carrier comprises one of an electronic signal, optical signal, radio signal or computer readable storage medium.

### BRIEF DESCRIPTION OF DRAWINGS

The solution will now be described in more detail by means of exemplary embodiments and with reference to the accompanying drawings, in which:

FIG. 1 is a communication scenario illustrating how network events and alarms are sent from elements in a communications network to an OSS node, according to the prior art.

FIG. 2 is a communication scenario illustrating an example of how the solution may be employed, according to some possible embodiments.

FIG. 3 is a flow chart illustrating a procedure in a control node, according to further possible embodiments.

FIG. 4 is a flow chart illustrating a procedure in a network element, according to further possible embodiments.

FIG. 5 is a block diagram illustrating an example of how the control node may be configured to operate, according to further possible embodiments.

FIG. 6 is a flow chart illustrating an example of how a training procedure may be executed in a control node, according to further possible embodiments.

FIG. 7 is a block diagram illustrating an example of how a control node and a network element may be configured, according to further possible embodiments.

FIG. 7A is a block diagram illustrating another example of how a control node and a network element may be configured, according to further possible embodiments.

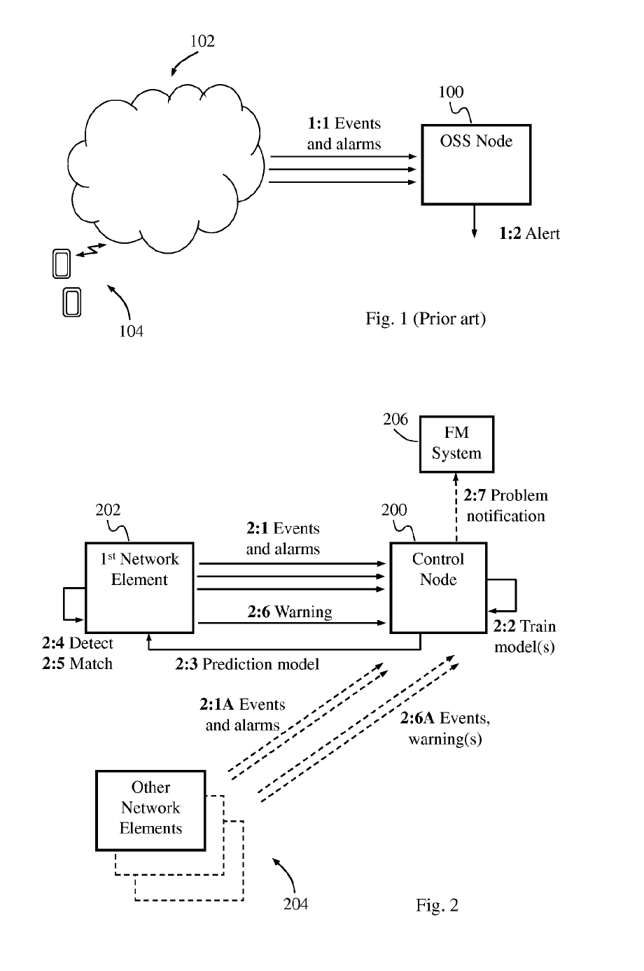

### DETAILED DESCRIPTION

A solution is provided to produce a warning of a predicted problem in a telecommunications network such that the warning is issued prior to the problem occurs. Thereby, it will be possible to take any appropriate actions in the network to proactively avoid or at least reduce the predicted and thus anticipated problem and any negative effects thereof. Various embodiments of the solution will be described in terms of functionality in a control node, such as an OSS or the like, and a network element of the telecommunications network, such as a network node, a communication link, or other part of the network capable of detecting and reporting network events. It should be noted that the functionality of the network element described herein may be applied in any number of network elements and the solution is not limited in this respect.

Briefly described, the solution is realized by means of a procedure carried out in the control node where a prediction model is defined and trained for the network element, and a procedure carried out in the network element where the prediction model is used for predicting a performance related problem that potentially needs to be addressed. The procedure in the control node may be performed in a training phase and the procedure in the network element may be performed in a usage phase, which terms will be referred to in the following. The training phase may continue as the usage phase has started so that the training and usage phases are not necessarily separated in time. Further, the training phase also involves the network element by reporting network events and/or alarms to the control node. The usage phase may also involve the control node by receiving a warning issued by the network element and possibly also warnings issued by other network elements. These warnings may be used for further training of the prediction model.

An example of how this solution could be used in a practical communication scenario will now be described with reference to FIG. 2, which illustrates how a control node 200 and a first network element 202 may operate when the solution is employed. It should be noted that the actions and embodiments described herein may be used for other network elements 204 as well, even though the example in FIG. 2 chiefly refers to the first network element 202.

A first action 2:1 indicates that the first network element 202 reports to the control node 200 various network events and/or alarms it has registered, e.g. by measuring some performance related parameters which may also be referred to as one or more performance indicators. This action may be performed more or less continuously during the above-mentioned training phase. The control node 200 may also receive network events and/or alarms from the other network elements 204, as indicated by a corresponding action 2:1A.

A next shown action 2:2 indicates that the control node 200 performs training of a prediction model, based on the network events and/or alarms, which model will be used by the first network element 202 for predicting a performance related problem that potentially needs to be addressed, as follows. When the prediction model has been defined and trained, the control node 200 sends the prediction model to the first network element 202, in another action 2:3, which basically concludes the training phase. Later, the control node 200 may execute another training phase and send an updated prediction model to the first network element 202, so as to improve its ability to predict problems in the network.

The first network element 202 then uses the received prediction model, i.e. in above-mentioned usage phase, by detecting further network events, as indicated by an action 2:4, and comparing the detected network events with the prediction model. If the first network element 202 finds that the detected network events match the prediction model, as indicated by another action 2:5, it can be deduced that a problem is likely forthcoming in the network before it actually occurs. The first network element 202 then issues a warning of the predicted problem in an action 2:6, which is received by the control node 200.

Depending on the implementation, the control node 200 may decide whether the received warning needs to be addressed or not, e.g. by also taking network events and warnings from any of the other network elements 204 into account. An action 2:6A illustrates that the control node 200 may receive such network events and warnings from the other network elements 204 as well. It will be described in more detail later below how the control node 200 may evaluate and handle such a received warning. In this example, the control node 200 decides that the received warning should be addressed and acted upon by a Fault Management, FM, system 206, and therefore sends a problem notification to the FM system 206, in a final shown action 2:7.

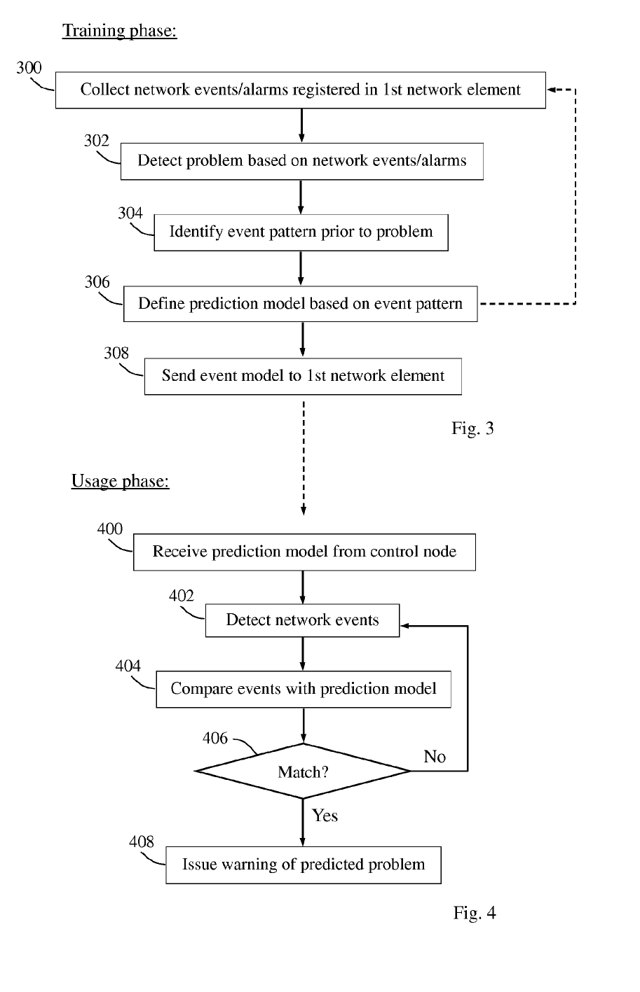

An example will now be described, with reference to the flow chart in FIG. 3, of how the solution can be employed in terms of actions which may be performed in a control node, such as the above-described control node 200, for handling network events occurring in a telecommunications network. Reference will sometimes also be made, without limiting the features described, to the example shown in FIG. 2. The procedure illustrated by FIG. 3 can thus be used to accomplish the functionality described above for the control node 200.

In some non-limiting examples, the control node 200 may be implemented in an OSS node, an Operation and Maintenance, O&M, node, or in any other suitable node of the network in question. Some example embodiments of the following procedure will also be described below. In some example embodiments, the first network element 202 may be any of: a network node, a switch, a subscriber database, a gateway, a communication link, and a router.

A first action 300 illustrates that the control node 200 collects network events and/or alarms from the first network element 202 in the telecommunications network during a training phase, e.g. in the manner described for action 2:1 above. In a further action 302, the control node 200 detects a performance related problem in the telecommunications network that potentially needs to be addressed, based on the collected network events and/or alarms.

In an example embodiment, the performance related problem may be detected when the collected network events indicate that a performance indicator registered at the first network element 202 deviates from a desired value or range. For example, no problem may be considered to be detected as long as the performance indicator stays within a “normal” or acceptable value or range, but if the collected network events indicate that the performance indicator starts to deviate from that value or range, it can be concluded that a performance related problem has been detected.

In some further example embodiments, the performance indicator may be related to one or more of the following non-limiting parameters or characteristics: bitrate, throughput, latency, error rate, failure rate such as amount of lost connections, number of dropped packets, and retransmission rate. The above-mentioned examples of performance indicator may be affected by current circumstances such as varying amount of traffic and interference as well as changing radio conditions. The performance indicator may also be affected by some fault and/or deteriorated function in the network element or in a nearby network element that affects performance in the first network element 202. The performance indicator may be comprised of one or more of the above-exemplified parameters, or it may be an aggregated parameter that is calculated from a combination of two or more of the above-exemplified parameters. Depending on the terminology used, the performance indicator may be referred to as a Key Performance Indicator, KPI.

In a following action 304, the control node 200 identifies an event pattern of network events that have occurred prior to detecting the performance related problem, based on the collected network events and/or alarms which have been stored by the control node 200 when collected in action 300.

In another action 306, the control node 200 further defines a prediction model for the first network element 202 based on the identified event pattern. Actions 300-306 may be repeated a number of times in order to train the prediction model to become more and more accurate based on an increasing number of detected performance related problems and preceding identified event patterns. As mentioned above, the control node 200 may update the prediction model in this way, e.g. at predetermined intervals, and send the updated prediction model to the first network element 202.

A final action 308 illustrates that the control node 200 sends the defined prediction model to the first network element 202, thereby enabling the first network element 202 to use the prediction model for predicting a forthcoming problem and to issue a warning of the predicted problem. After action 308, the control node 200 may repeat actions 300-306 in order to refine and/or update the prediction model which can be sent again to the first network element 202 in updated form.

The prediction model defined in action 306 thus reflects the event pattern identified in action 304, and when the prediction model used, that is in the usage phase, the first network element 202 is able to recognize if the same or similar event pattern occurs again by comparing a current detected event pattern with the prediction model. In that case, a warning is warranted since it is likely that the problem will occur again as a result of the occurrence of an event pattern that matches the prediction model. The above procedure may further be performed for a group of network nodes such that the resulting prediction model is useful for the network nodes in the group.

Some further embodiments and examples of how the above procedure in FIG. 3 may be realized will now be outlined. In one example embodiment, the prediction model may be updated by repeating the method when requested or at predefined intervals. In another example embodiment, as an alternative to checking whether a performance indicator deviates from a desired value or range, the control node 200 may detect the performance related problem by receiving an alarm from the first network element 202. In that case, another example embodiment may be that the control node 200 detects the performance related problem and identifies the event pattern when the received alarm fulfils a predefined significance condition while disregarding any received alarms that do not fulfil the predefined significance condition.

In another example embodiment, network events and/or alarms may be collected from multiple network elements 202, 204 and an event pattern may be identified for each network element. In this case the prediction model may be defined for the multiple network elements 202, 204 jointly.

When the first network element 202 has received the prediction model as of action 308, and has started to compare further network events with the prediction model, it may issue a warning when any detected current network events match the prediction model. In another example embodiment, a warning of a predicted problem may thus be received from the first network element 202 during a usage phase, which corresponds to action 2:6 above. In this case, another example embodiment may be that the control node 200 collects network events from one or more other network elements 204 during the usage phase, as of action 2:6A. The control node 200 may then send a notification of the predicted problem to a Fault Management, FM, system 206, based on the warning received from the first network element 202 and further based on the network events collected from the one or more other network elements 204. For example, it may be required that the warning must occur in combination with certain network events registered by the one or more other network elements 204, before the notification is sent to the FM system 206.

An example will now be described, with reference to the flow chart in FIG. 4, of how the solution can be employed in terms of actions which may be performed in a network element, such as the above-described first network element 202, for handling network events occurring in a telecommunications network. Reference will again also be made, without limiting the features described, to the example shown in FIG. 2. The procedure illustrated by FIG. 4 can thus be used to accomplish the functionality described above for the first network element 202. It is assumed that the network element in this procedure is capable of detecting network events, e.g. by performing various measurements and observations of ongoing data traffic, and of using a prediction model in the following manner.

A first action 400 illustrates that the network element 202 receives a prediction model from a control node 200 which prediction model is useful for predicting a forthcoming problem. Action 400 corresponds to actions 2:3 and 308. In another action 402, the network element 202 detects network events, which corresponds to actions 2:4. In a further action 404, the network element 202 compares the detected network events and the received prediction model.

The network element 202 determines, in an action 406, whether the detected network events match the prediction model. If so, the network element 202 issues a warning of a predicted problem in a final shown action 408. If no match is found in action 406, the procedure continues by returning to action 400. The procedure according to actions 400-406 is generally performed more or less continuously and whenever a match between detected network events and the prediction model is found, the network element 202 will issue a warning of action 408.

In an example embodiment, the warning may be sent to the control node 200 which in turn may evaluate the warning and decide to send a notification of the predicted problem to an FM system or the like, as described above. In further example embodiments, the network element may be any of: a network node, a subscriber database, a gateway, a communication link, and a router.

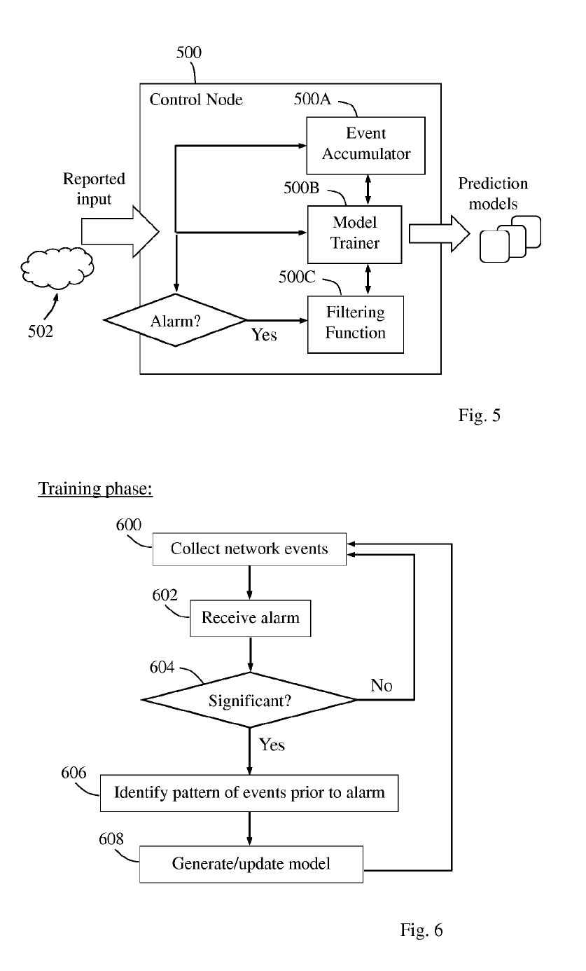

FIG. 5 illustrates an example of how a control node 500 corresponding to the control node 200 may be configured with different functional blocks. It is illustrated that the control node 500 receives data, or “input”, as reported from various network elements in a telecommunications network 502, which includes the above-described network events and/or alarms. An event accumulator 500A is operable in the control node 500 to collect such network events and/or alarms, as of action 300. A model trainer 500B is further operable in the control node 500 to define and train the above-described prediction model based on the collected network events and/or alarms, in the manner described above for actions 302-306. The model trainer 500B is further operable to output prediction models to different network elements, as of action 308.

The control node 500 may further comprise a filtering function 500C which is operable to filter out alarms of a certain significance, e.g. depending on a predefined significance condition, which may also include warnings issued according to the trained prediction model. Thereby, only sufficiently significant alarms and warnings are provided to the model trainer 500B while any incoming alarms that do not fulfil the predefined significance condition are disregarded.

It was mentioned above that a performance related problem may be detected when an alarm issued by the first network element fulfils a predefined significance condition, according to one embodiment. Another example of a procedure performed by a control node will now be described with reference to the flow chart in FIG. 6 which illustrates basically how the above-described training phase may be implemented when the above embodiment is used in training a prediction model for a first network element.

In a first action 600, the control node collects network events from the first network element and possibly also from one or more other network elements that may, directly or indirectly, be related to the performance of the first network element. In a next action 602, the control node receives an alarm from the first network element which alarm may have been triggered in the first network element when a monitored parameter or performance indicator is above or below some predefined threshold. Alternatively, the control node may in this action receive an alarm from any of the other network elements related to the performance of the first network element.

In a further action 604, the control node determines whether the received alarm is significant or not by checking whether it fulfils a predefined significance condition or not. If not significant, the received alarm is disregarded by the control node and the procedure may return to action 600. If the received alarm is determined to be significant in action 604, an action 606 illustrates that the control node identifies a pattern of network events that have occurred prior to receiving the alarm, based on the network events collected in action 600. A final action 608 illustrates that the control node generates or updates the prediction model based on the event pattern identified in action 606. Thereafter, the procedure may return to action 600 for further training of the prediction model by repeating actions 600-608.

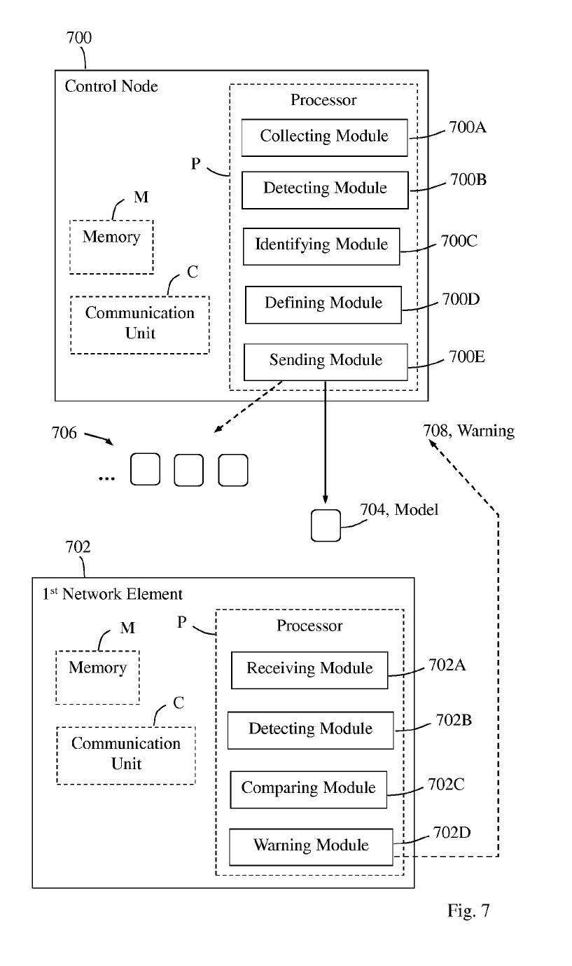

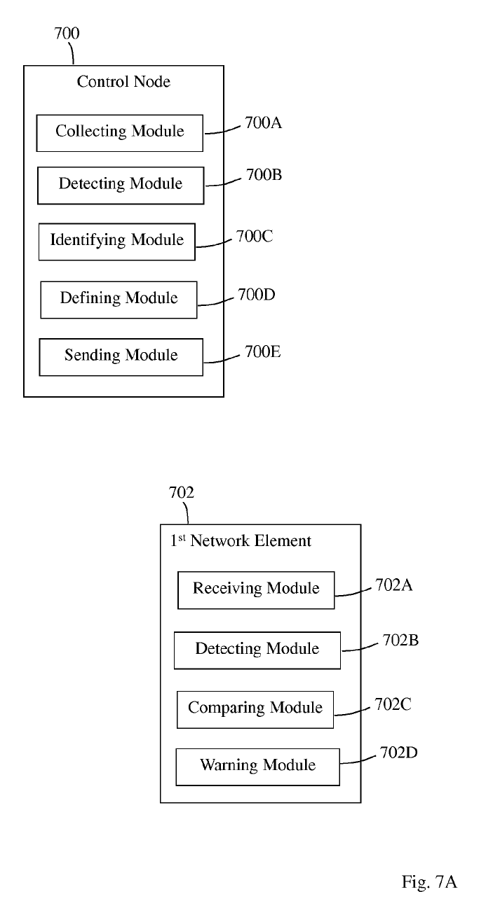

The block diagram in FIG. 7 illustrates a detailed but non-limiting example of how a control node 700 and a network element 702, respectively, may be structured to bring about the above-described solution and embodiments thereof. In this figure, the control node 700 and the network element 702 may be configured to operate according to any of the examples and embodiments of employing the solution as described herein, where appropriate. Each of the control node 700 and the network element 702 is shown to comprise a processor “P”, a memory “M” and a communication circuit “C” with suitable equipment for sending and receiving messages in the manner described herein.

The communication circuit C in each of the control node 700 and the network element 702 thus comprises equipment configured for communication with each other using a suitable protocol for the communication depending on the implementation. The solution is however not limited to any specific types of messages or protocols. As a practical but non-limiting example, the messages described herein including the reporting of network events and/or alarms from the network element, the sending of the prediction model the control node and warnings from the network element, may be communicated by means of the Hyper Text Transfer Protocol, HTTP, or the File Transfer Protocol, FTP.

The control node 700 is, e.g. by means of modules, units or the like, configured or arranged to perform at least some of the actions of the flow chart in FIG. 3 as follows. Further, the network element 702 is, e.g. by means of modules, units or the like, operative or arranged to perform at least some of the actions of the flow chart in FIG. 4 as follows.

The control node 700 is arranged to handle network events occurring in a telecommunications network. The control node 700 comprises a memory and a processor, the memory containing instructions executable by the processor such that the control node 700 is operative as follows. The control node 700 is operative to collect network events and/or alarms from a first network element 702 in the telecommunications network during a training phase. This operation may be performed by a collecting module 700A in the control node 700, as described above for action 300. The collecting module 700A may be operative to collect network events and/or alarms from any number of other network elements in the telecommunications network as well. The collecting module 700A could alternatively be named a gathering module or registering module.

The control node 700 is also operative to detect a performance related problem in the telecommunications network that potentially needs to be addressed, based on the collected network events and/or alarms. This operation may be performed by a detecting module 700B in the control node 700, as described above for action 302. The detecting module 700B could alternatively be named an identifying module or monitoring module.

The control node 700 is further operative to identify an event pattern of network events that have occurred prior to detecting the performance related problem, based on the collected network events and/or alarms. This operation may be performed by an identifying module 700C in the control node 700, as described above for action 306. The identifying module 700C could alternatively be named a logic module or analysing module.

The control node 700 is further operative to define a prediction model for the first network element 702 based on the identified event pattern. This operation may be performed by a defining module 700D in the control node 700, as described above for action 308. The defining module 700D could alternatively be named a training module or creating module.

The control node 700 is further operative to send the defined prediction model to the first network element 702. This operation may be performed by a sending module 700E in the control node 700 as described above for action 308. Thereby, the first network element 702 is enabled to use the prediction model for predicting a forthcoming problem and to issue a warning of the predicted problem. The sending module 700E could alternatively be named a transmitting module or configuring module.

The network element 702 is arranged to handle network events occurring in a telecommunications network. The network element 702 comprises a memory and a processor, the memory containing instructions executable by the processor such that the network element 702 is operative as follows. The network element 702 is operative to receive a prediction model from a control node 700 which prediction model is useful for predicting a forthcoming problem. This operation may be performed by a receiving module 702A in the network element 702, as described above for action 400. The network element 702 is further operative to detect network events. This operation may be performed by a detecting module 702B in the network element 702, as described above for action 402. The detecting module 702B could alternatively be named a monitoring module or registering module.

The network element 702 is further operative to compare the detected network events and the received prediction model. This operation may be performed by a comparing module 702C in the network element 702, as described above for actions 404, 406. The comparing module 702C could alternatively be named a logic module. The network element 702 is further operative to issue a warning of a predicted problem when the detected network events match the prediction model. This operation may be performed by a warning module 702D in the network element 702, as described above for action 408. The warning module 702D could alternatively be named an issuing module.

Another example of how the control node 700 and the network element 702 may be configured is schematically shown in the block diagram of FIG. 7A. In this example, the control node 700 comprises the functional modules 700A-700E, the modules 700A-700E being configured to operate in the manner described above with reference to FIGS. 3 and 7. Further, the network element 702 comprises the functional modules 702A-702D, the modules 702A-702D being configured to operate in the manner described above with reference to FIGS. 4 and 7.

Each of FIGS. 7 and 7A further illustrates a system comprising both the control node 700 and the network element 702, the control node 700 and the network element 702 being operative as described above.

It should be noted that FIG. 7 illustrates various functional modules in the control node 700 and the network element 702, respectively, and the skilled person is able to implement these functional modules in practice using suitable software and hardware equipment. Thus, the solution is generally not limited to the shown structures of the control node 700 and the network element 702, and the functional modules therein may be configured to operate according to any of the features, examples and embodiments described in this disclosure, where appropriate.

The functional modules 700A-E and 702A-D described above may be implemented in the control node 700 and the network element 702, respectively, by means of program modules of a respective computer program comprising code means which, when run by the processor P causes the control node 700 and the network element 702 to perform the above-described actions and procedures. Each processor P may comprise a single Central Processing Unit (CPU), or could comprise two or more processing units. For example, each processor P may include a general purpose microprocessor, an instruction set processor and/or related chips sets and/or a special purpose microprocessor such as an Application Specific Integrated Circuit (ASIC). Each processor P may also comprise a storage for caching purposes.

Each computer program may be carried by a computer program product in each of the control node 700 and the network element 702 in the form of a memory having a computer readable medium and being connected to the processor P. The computer program product or memory M in each of the control node 700 and the network element 702 thus comprises a computer readable medium on which the computer program is stored e.g. in the form of computer program modules or the like. For example, the memory M in each node may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the respective control node 700 and network element 702.

The solution described herein may be implemented in each of the control node 700 and the network element 702 by a computer program comprising instructions which, when executed on at least one processor, cause the at least one processor to carry out the actions according to any of the above embodiments and examples, where appropriate. The solution may also be implemented at each of the control node 700 and the network element 702 in a computer program storage product comprising instructions which, when executed on the control node 700 and the network element 702, cause the control node 700 and the network element 702 to carry out the actions according to the above respective embodiments, where appropriate.

In conclusion, advantages that may be achieved by employing the solution and its embodiments described herein includes the following. A proactive handling of problems in the network is possible, meaning that the problems can be anticipated and even addressed proactively before they actually occur. The warnings can also be made accurate and relevant over time by employing the training phase on a continuous or regular basis, e.g. at the same time the usage phase is employed, so that the prediction model can be kept up-to-date according to changing conditions. Thereby, any insignificant or useless alarms can be avoided which in turn will result in less signaling and data transmission as well as less work required in dealing with such alarms. Furthermore, the prediction model can be adapted to changing traffic characteristics, e.g. when more smartphones and/or so-called Internet-of-Things, IoT, devices are used in the network and new communication services are introduced.

While the solution has been described with reference to specific exemplifying embodiments, the description is generally only intended to illustrate the inventive concept and should not be taken as limiting the scope of the solution. For example, the terms “control node”, “network element”, “network event”, “performance related problem”, “event pattern”, “prediction model”, “warning”, “performance indicator”, and “significance condition” have been used throughout this disclosure, although any other corresponding entities, functions, and/or parameters could also be used having the features and characteristics described here. The solution is defined by the appended claims.

1. A method performed by a control node for handling network events occurring in a telecommunications network, the method comprising:
collecting network events and/or alarms from a first network element in the telecommunications network during a training phase;
detecting a performance related problem in the telecommunications network that potentially needs to be addressed, based on the collected network events and/or alarms;
identifying an event pattern of network events that have occurred prior to detecting the performance related problem, based on the collected network events and/or alarms;
defining a prediction model for the first network element based on the identified event pattern; and
sending the defined prediction model to the first network element, thereby enabling the first network element to use the prediction model for predicting a forthcoming problem and to issue a warning of the predicted problem.

2-5. (canceled)

6. The method of claim 1, wherein the prediction model is updated by repeating the method when requested or at predefined intervals.

7. The method of claim 1, wherein the first network element is any of: a network node, a switch, a subscriber database, a gateway, a communication link, and a router.

8. The method of claim 1, wherein network events and/or alarms are collected from multiple network elements and an event pattern is identified for each network element, and wherein the prediction model is defined for the multiple network elements jointly.

9. The method of claim 1, wherein a warning of a predicted problem is received from the first network element during a usage phase.

10. The method of claim 9, wherein network events are collected from one or more other network elements during the usage phase, and a notification of the predicted problem is sent to a Fault Management, FM, system, based on the warning received from the first network element and the network events collected from the one or more other network elements.

11. A control node arranged to handle network events occurring in a telecommunications network, the control node comprising a memory (M) and a processor (P), the memory containing instructions executable by the processor such that the control node is operative to:
collect network events and/or alarms from a first network element in the telecommunications network during a training phase;
detect a performance related problem in the telecommunications network that potentially needs to be addressed, based on the collected network events and/or alarms;
identify an event pattern of network events that have occurred prior to detecting the performance related problem, based on the collected network events and/or alarms;
define a prediction model for the first network element based on the identified event pattern; and
send the defined prediction model to the first network element, thereby enabling the first network element to use the prediction model for predicting a forthcoming problem and to issue a warning of the predicted problem.

12. The control node of claim 11, wherein the control node is configured to detect the performance related problem when the collected network events indicate that a performance indicator registered at the first network element deviates from a desired value or range.

13. The control node of claim 12, wherein the performance indicator is related to one or more of: bitrate, throughput, latency, error rate, failure rate such as amount of lost connections, number of dropped packets, and retransmission rate.

14. The control node of claim 11, wherein the control node is configured to detect the performance related problem by receiving an alarm from the first network element.

15. The control node of claim 14, wherein the control node is configured to detect the performance related problem and identify the event pattern when the received alarm fulfils a predefined significance condition, and to disregard any received alarms that do not fulfil the predefined significance condition.

16. The control node of claim 11, wherein the control node is configured to update the prediction model when requested or at predefined intervals.

17. The control node of claim 11, wherein the first network element is any of: a network node, a switch, a subscriber database, a gateway, a communication link, and a router.

18. The control node of claim 11, wherein the control node is configured to collect network events and/or alarms from multiple network elements, to identify an event pattern for each network element based on the respective collected network events and/or alarms, and to define the prediction model for the multiple network elements jointly based on the identified event patterns.

19. The control node of claim 11, wherein the control node is configured to receive a warning of a predicted problem from the first network element during a usage phase.

20. The control node of claim 19, wherein the control node is configured to collect network events from one or more other network elements during the usage phase, and to send a notification of the predicted problem to a Fault Management, FM, system, based on the warning received from the first network element and the network events collected from the one or more other network elements.

21. A method performed by a network element for handling network events occurring in a telecommunications network, the method comprising:
receiving a prediction model from a control node which prediction model is useful for predicting a forthcoming problem;
detecting network events, events;
comparing the detected network events and the received prediction model; and
issuing a warning of a predicted problem when the detected network events match the prediction model.

22. (canceled)

23. (canceled)

24. A network element arranged to handle network events occurring in a telecommunications network, the network element comprising a memory (M) and a processor (P), the memory containing instructions executable by the processor such that the network element is operative to:
receive a prediction model from a control node which prediction model is useful for predicting a forthcoming problem,
detect network events,
compare the detected network events and the received prediction model, and issue a warning of a predicted problem when the detected network events match the prediction model.

25. The network element of claim 24, wherein the network element is configured to send the warning to the control node.

26. The network element of claim 24, wherein the network element is: a network node, a subscriber database, a gateway, a communication link, or a router.

27-31. (canceled)
